(19) United States
(12) Patent Application Publication
(10) Pub. No.: US 2017/0366854 A1
(43) Pub. Date: Dec. 21, 2017

(54) SYSTEMS AND METHODS FOR EVENT BROADCASTS

(71) Applicant: Facebook, Inc., Menlo Park, CA (US)

(72) Inventors: Amit Puntambekar, Fremont, CA (US); Michael Hamilton Coward, Solana Beach, CA (US); Maher Afif Saba, Seattle, WA (US)

(21) Appl. No.: 15/237,491

(22) Filed: Aug. 15, 2016

Related U.S. Application Data
(60) Provisional application No. 62/352,973, filed on Jun. 21, 2016.

(51) Int. Cl. H04N 21/475; H04N 21/45; H04N 21/466; H04N 21/472

(52) U.S. Cl. CPC H04N 21/4758; H04N 21/472; H04N 21/4524; H04N 21/4532; H04N 21/4662

(57) ABSTRACT

Systems, methods, and non-transitory computer-readable media can determine a broadcaster request to determine information for conducting a content broadcast through the computing system. One or more parameters for the broadcast can be determined using a machine learning model that has been trained to predict the one or more parameters based at least in part on data describing previously conducted broadcasts. Information that describes at least the one or more parameters is provided to the broadcaster.

### CROSS-REFERENCE TO RELATED APPLICATIONS

This application claims priority to U.S. Provisional Patent Application No. 62/352,973, filed on Jun. 21, 2016 and entitled “Systems and Methods for Event Broadcasts”, which is incorporated in their entireties herein by reference.

### FIELD OF THE INVENTION

The present technology relates to the field of content provision. More particularly, the present technology relates to techniques for providing live broadcasts to users.

### BACKGROUND

Today, people often utilize computing devices (or systems) for a wide variety of purposes. Users can use their computing devices to, for example, interact with one another, access content, share content, and create content. For example, users can stream content through their computing devices. In general, content can be streamed from a content provider that sends encoded data (e.g., audio, video, or both) to a computing device of an end-user. The computing device receiving the streamed data can decode and present the content through the computing device.

### SUMMARY

Various embodiments of the present disclosure can include systems, methods, and non-transitory computer readable media configured to determine a broadcaster request to determine information for conducting a content broadcast through the computing system. One or more parameters for the broadcast can be determined using a machine learning model that has been trained to predict the one or more parameters based at least in part on data describing previously conducted broadcasts. Information that describes at least the one or more parameters is provided to the broadcaster.

In an embodiment, the systems, methods, and non-transitory computer readable media are configured to determine at least one time period for conducting the broadcast based at least in part on the model, wherein at least a threshold number of users are expected to access the broadcast for at least a portion of the time period.

In an embodiment, the systems, methods, and non-transitory computer readable media are configured to determine at least one topic for the broadcast based at least in part on the model, wherein at least a threshold number of users are expected to access the broadcast when conducted on the at least one topic.

In an embodiment, the at least one topic for the broadcast is automatically generated based on at least one of: information specified in a social profile of the broadcaster, topics corresponding to posts that were published by the broadcaster through a social networking system, or a geographic location corresponding to the broadcaster.

In an embodiment, the systems, methods, and non-transitory computer readable media are configured to determine at least one geographic location from which to conduct the broadcast based at least in part on the model, wherein at least a threshold number of users are expected to access the broadcast when conducted from the at least one geographic location.

In an embodiment, the systems, methods, and non-transitory computer readable media are configured to determine information describing users that are expected to access the broadcast based at least in part on the model.

In an embodiment, the information includes at least one of: the number of users or demographic information describing the users.

In an embodiment, the systems, methods, and non-transitory computer readable media are configured to cause an audience for the broadcast to be built, wherein the audience comprises a set of users that are interested in the broadcast, determine that a size of the audience satisfies a threshold, and provide at least one notification to the broadcaster, the notification describing the set of users that are interested in the broadcast.

In an embodiment, the systems, methods, and non-transitory computer readable media are configured to provide one or more notifications to the set of users to inform the users about the broadcast.

In an embodiment, the systems, methods, and non-transitory computer readable media are configured to provide one or more polling questionnaires to the set of users to inform the users about the broadcast and determine a number of the users that are interested in the broadcast.

Various embodiments of the present disclosure can include systems, methods, and non-transitory computer readable media configured to determine a request for a first user to initiate a content broadcast through the computing system, the request being sent by a second user. One or more parameters for the broadcast can be determined. At least one notification that describes the request can be provided to the first user, the notification including information describing the one or more parameters.

In an embodiment, the systems, methods, and non-transitory computer readable media are configured to provide a polling questionnaire to one of more users of the computing system, the polling questionnaire requesting feedback for at least one topic for the broadcast and obtain feedback from at least one of the users in response to the polling questionnaire, wherein the feedback is included in the notification provided to the first user.

In an embodiment, the at least one topic for the broadcast is automatically generated based on information specified in a social profile of the first user.

In an embodiment, the at least one topic for the broadcast is automatically generated based on topics corresponding to posts that were published by the first user through a social networking system.

In an embodiment, the at least one topic for the broadcast is automatically generated based on a geographic location corresponding to the first user.

In an embodiment, the polling questionnaire is provided to a user as a content item in a content feed associated with the user.

In an embodiment, the systems, methods, and non-transitory computer readable media are configured to provide a polling questionnaire to one of more users of the computing system, the polling questionnaire requesting feedback for at least one time for conducting the broadcast and obtain feedback from at least one of the users in response to the polling questionnaire, wherein the feedback is included in the notification provided to the first user.

In an embodiment, the systems, methods, and non-transitory computer readable media are configured to provide a polling questionnaire to one of more users of the computing system, the polling questionnaire requesting feedback for at least one geographic location from which to conduct the broadcast and obtain feedback from at least one of the users in response to the polling questionnaire, wherein the feedback is included in the notification provided to the first user.

In an embodiment, the systems, methods, and non-transitory computer readable media are configured to provide a polling questionnaire to one of more users of the computing system, the polling questionnaire requesting feedback on whether the users are interested in viewing the broadcast, obtain feedback from at least one of the users in response to the polling questionnaire, and determine information describing an audience that is interested in the broadcast based at least in part on the feedback, wherein the information is included in the notification provided to the first user.

In an embodiment, the information describing the audience includes at least one of information describing users that are interested in the broadcast, a size of the audience, demographic information describing the users interested in the broadcast.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module, according to an embodiment of the present disclosure.

FIG. 2 illustrates an example of a broadcast request module, according to an embodiment of the present disclosure.

FIG. 3 illustrates an example of a broadcast optimization module, according to an embodiment of the present disclosure.

FIG. 4 illustrates an example of a broadcast suggestion module, according to an embodiment of the present disclosure.

FIG. 5 illustrates an example process for requesting a content broadcast, according to various embodiments of the present disclosure.

FIG. 6 illustrates an example process for determining information for a content broadcast, according to various embodiments of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Event Broadcasts

Today, people often utilize computing devices (or systems) for a wide variety of purposes. Users can use their computing devices to, for example, interact with one another, access content, share content, and create content. For example, users can stream content through their computing devices. In general, content can be streamed from a content provider that sends encoded data (e.g., audio, video, or both) to a computing device of an end-user. The computing device receiving the streamed data can decode and present the content through the computing device.

Under conventional approaches, a live broadcast of an event can be captured using some recording apparatus and be made available to users through a content provider. A user operating a computing device can request streaming of the live broadcast from the content provider. Upon processing the request, the content provider can send data corresponding to the live stream to the computing device of the user. The computing device can decode and present the data on a display screen of the computing device. Events being broadcasted live may be scheduled in advance or be conducted impromptu. When scheduling broadcasts, publishers of events (e.g., broadcasters) are typically unaware of the optimal time(s) for conducting a broadcast and/or the topic(s) that are most likely to elicit an optimal number of viewers. Conducting broadcasts without such information may result in a weaker viewer turnout. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In some embodiments, a machine learning model can be used by publishers to determine broadcast-related information, such as optimal times for conducting a broadcast, topics for a broadcast, and/or a geographic location for a broadcast, to name some examples. In some embodiments, a crowd-sourced approach can be used by publishers to poll their audience for suggestions pertaining to optimal times for conducting a broadcast, topics for a broadcast, and/or geographic locations for a broadcast, to name some examples. In some embodiments, users can submit requests to a user (e.g., a friend, celebrity, etc.) asking the user to conduct a live broadcast on a specified time and/or at a specified time. In general, such approaches allow publishers to conduct their broadcasts at optimal times and/or on the best topics to improve the size of their viewing audience and/or reach. In various embodiments, broadcasts times and/or topics may be enhanced to satisfy a desired reach. The reach may refer to a particular audience that is being targeted such as a particular demographic of users. In some embodiments, the reach may refer to a particular objective to be achieved such as the audience to be targeted for achieving an objective, e.g., a specified amount of sales, a specified number of clicks, a specified amount of user engagement, etc. Depending on the privacy setting specified by the broadcaster, a broadcast may be available for access by the general public or limited to a set of users as specified by the broadcaster, for example.

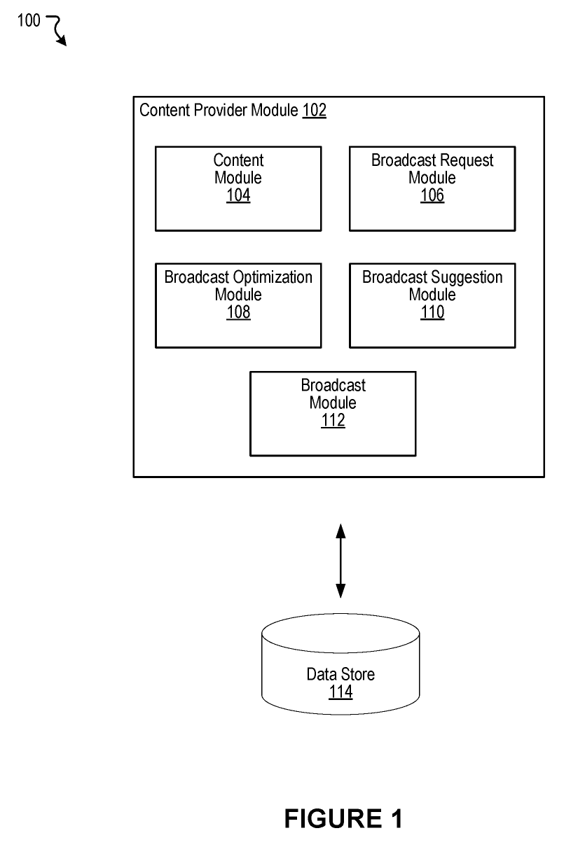

FIG. 1 illustrates an example system 100 including an example content provider module 102, according to an embodiment of the present disclosure. As shown in the example of FIG. 1, the content provider module 102 can include a content module 104, a broadcast request module 106, a broadcast optimization module 108, a broadcast suggestion module 110, and a broadcast module 112. In some instances, the example system 100 can include at least one data store 114. The components (e.g., modules, elements, etc.) shown in this figure and all figures herein are examples only, and other implementations may include additional, fewer, integrated, or different components. Some components may not be shown so as not to obscure relevant details.

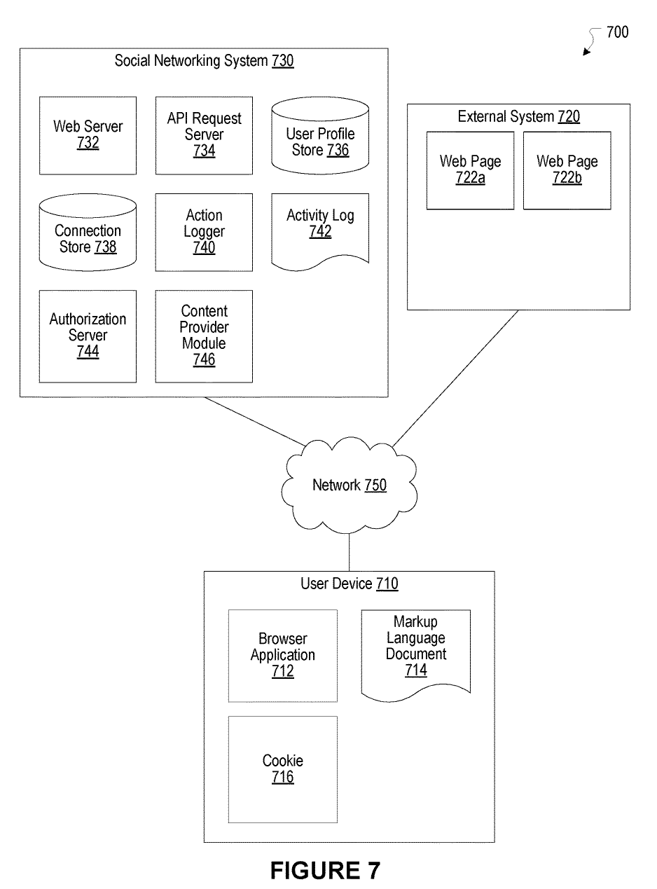

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user or client computing device. In one example, the content provider module 102 or at least a portion thereof can be implemented as or within an application (e.g., app), a program, or an applet, etc., running on a user computing device or a client computing system, such as the user device 710 of FIG. 7. In another example, the content provider module 102 or at least a portion thereof can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 730 of FIG. 7.

The content provider module 102 can be configured to communicate and/or operate with the at least one data store 114, as shown in the example system 100. The at least one data store 114 can be configured to store and maintain various types of data. For example, the data store 114 can store information describing content items, e.g., broadcasts, that were created and made available to users. In some implementations, the at least one data store 114 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 114 can store information associated with users, such as user identifiers, user information, profile information, user specified settings, content produced or posted by users, and various other types of user data.

The content module 104 can be configured to provide access to various content items, e.g., broadcasts, that are available through the content provider module 102. For example, in some embodiments, a user operating a computing device can interact with the content module 104, for example, through an interface (e.g., graphical user interface, application programming interface, etc.) to access, e.g., stream, various content items that are available. When a user requests access to a content item, the content module 104 can service the request by causing data (e.g., encoded data) corresponding to the content item to be sent to the computing device of the user. The computing device of the user can process the received data (e.g., decode the data) so that the content item can be presented on a display screen of the computing device.

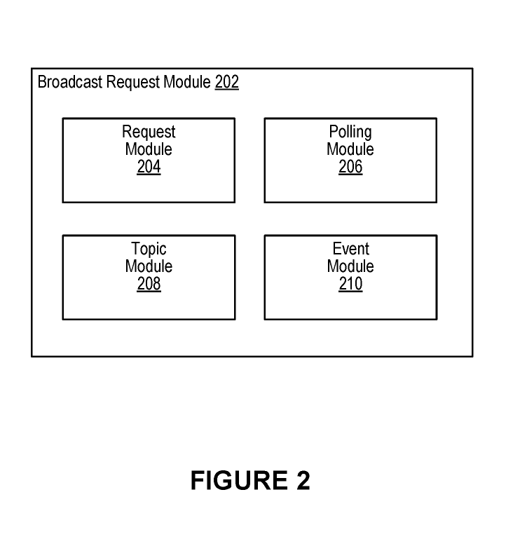

The broadcast request module 106 can be configured to allow users to submit requests asking another user (e.g., a friend, celebrity, etc.) to conduct a broadcast (e.g., live content stream). More details regarding the broadcast request module 106 will be provided below in reference to FIG. 2.

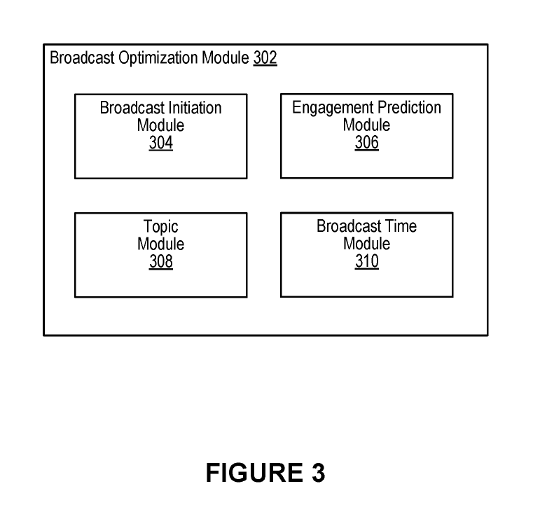

The broadcast optimization module 108 can be configured to provide broadcasters with information such as times and/or topics that are predicted to drive optimal user engagement for a broadcast. More details regarding the broadcast optimization module 108 will be provided below in reference to FIG. 3.

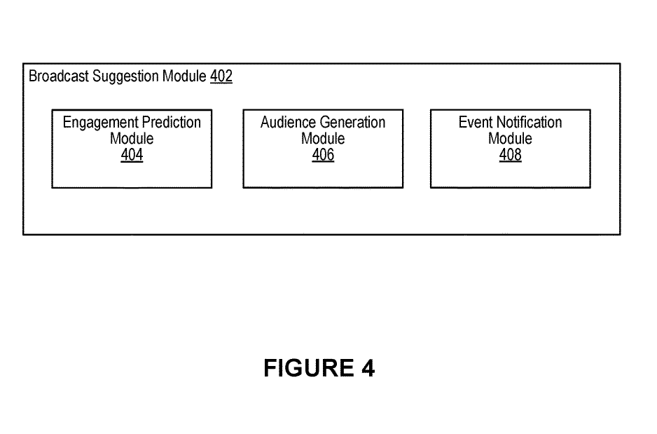

The broadcast suggestion module 110 can be configured to automatically determine a broadcast event for a broadcaster. The broadcast suggestion module 110 can also generate an audience for the broadcast event and, when appropriate, provide a suggestion to the first user to conduct a broadcast. More details regarding the broadcast suggestion module 110 will be provided below in reference to FIG. 4.

The broadcast module 112 can be utilized by users of the content provider to initiate broadcasts (e.g., live content streams). When initiating a live content stream, the broadcast module 112 can be utilized by a broadcaster to communicate data describing the content that was captured using the broadcaster's computing device to the content provider. The broadcast module 112 can utilize any generally known techniques that allow for live streaming of content including, for example, the Real Time Messaging Protocol (RTMP).

FIG. 2 illustrates an example of a broadcast request module 202, according to an embodiment of the present disclosure. In some embodiments, the broadcast request module 106 of FIG. 1 can be implemented as the broadcast request module 202. As shown in FIG. 2, the broadcast request module 202 can include a request module 204, a polling module 206, a topic module 208, and an event module 210.

As mentioned, the broadcast request module 202 can be configured to allow users (e.g., users of the social networking system 730 of FIG. 7) to submit requests asking other users to conduct broadcasts. In various embodiments, users can make such requests through the request module 204. The request module 204 can be configured to receive broadcast requests from one or more users, for example, through an interface (e.g., graphical user interface, application programming interface, etc.). A request may specify one or more parameters for the broadcast. For example, in some embodiments, the request may identify a broadcaster that is being asked to conduct the broadcast. In some embodiments, the request may also specify one or more requested topics for the broadcast and/or one or more requested times (e.g., date, time of day, etc.) for the broadcast. Once a request is received, the request module 204 can send a notification to the broadcaster being asked to present the broadcast. For example, the notification may be communicated through a software application running on a computing device of the broadcaster. The broadcaster then has the option of initiating the broadcast through the content provider (e.g., the social networking system 730 of FIG. 7) based on the parameters that were specified in the request. In some embodiments, the broadcaster can initiate the broadcast through the broadcast module 112 of FIG. 1.

In some instances, the request may only identify the broadcaster without specifying a topic or a time for the broadcast. For example, the user that submitted the request may just be interested in hearing the broadcaster speak on any topic and/or at any time. In such instances, the polling module 206 can be configured to poll users through the social networking system for additional information that may be useful to the broadcaster for planning the broadcast. For example, the polling module 206 can provide questionnaires to users to obtain various feedback. In some embodiments, the questionnaire can include a freeform field in which users can propose topics for the broadcast. If the initial broadcast request specified a set of proposed topics, the polling module 206 can provide questionnaires to users asking them to select one or more of the proposed topics for the broadcast. In another example, the questionnaire can ask users to select one or more times from a set of proposed times for the broadcast. Similarly, in some embodiments, the questionnaire can include a freeform field in which users can specify broadcast times that have not already been proposed. In some embodiments, the questionnaire can ask users to select, or specify, one or more geographic locations from which the broadcaster should conduct the broadcast. For example, users may want the broadcaster to conduct the broadcast from the set of a new movie being filmed.

When polling, the polling module 206 can present a poll, or questionnaire, in a content feed of a user being polled. In general, a content feed may be provided by the social networking system for presentation through a display screen of a computing device of a user. The content feed can include various content items that have been determined by the social networking system to be relevant, or of interest, to the user. A poll or questionnaire can be included as a content item in the content feed. In various embodiments, the content feed can be accessed through a software application (e.g., social networking application, browser, etc.) running on the computing device of the user. In some embodiments, the polling module 206 polls users that are recognized as social connections of the broadcaster in the social networking system. In some embodiments, the polling module 206 polls users that are recognized as social connections of the user that submitted the request. In some embodiments, the polling module 206 polls users of the social networking system that have selected options to “like” or “fan” a page corresponding to the broadcaster and/or users that have otherwise been identified by the social networking system as fans of the broadcaster. Naturally, the users polled can vary depending on the implementation. For example, in some embodiments, the polling can be extended to users that are recognized as social connections having additional degrees of separation (e.g., second degree social connections, third degree social connections, etc.) from the broadcaster, the user that submitted the request, social connections of the broadcaster, and/or social connections of the user that submitted the request.

In some instances, a broadcasting request sent to the broadcaster may not be enough to encourage the broadcaster to conduct the broadcast. In such instances, the request may be more persuasive if an audience for the broadcast is established prior to sending the notification to the broadcaster. Thus, in some embodiments, when the broadcasting request is received, the polling module 206 can be configured to determine an audience of users that are interested in the broadcast. For example, the polling module 206 can poll other users to determine which users are interested in viewing the broadcast. In this example, the polling questionnaire may indicate that there is interest in having the broadcaster conduct a broadcast on one or more topics and ask if the user being polled is also interested in viewing the broadcast (e.g., “Your friend John Doe is interested in having Jane Doe speak on video encoding. Are you interested?”). Based on feedback in response to the questionnaire, the polling module 206 can determine which users are interested in the broadcast as well as a total number of users that have indicated an interest. In some embodiments, the polling module 206 determines demographic information (e.g., age group, gender, affiliations, interests, etc.) for the users that are interested in the broadcast. In some embodiments, such information can be included in the notification that is sent to the broadcaster. For example, the notification to the broadcaster can indicate that 30 users are interested in hearing the first user speak on video encoding and that all of these users reside in California.

In some embodiments, the topic module 208 can be configured to automatically suggest topics for the broadcast. For example, the topic module 208 may determine topics based on information (e.g., interests, hobbies, etc.) that are specified in a social profile of the broadcaster. In some embodiments, the topic module 208 may determine topics based on any groups of which the broadcaster is a member (e.g., fan) in the social networking system. For example, various groups in the social networking system may be affiliated with one or more topics. The topics associated with groups of which the broadcaster is a member can be suggested as topics for the broadcast. In some embodiments, the topic module 208 may determine topics based on posts published by the broadcaster through the social networking system. For example, if the broadcaster often posts on topics relating to video encoding, volcanic activity, and bird watching, then such topics can be suggested as topics for the broadcast. In some embodiments, the topic module 208 may determine proposed topics based on a geographic location corresponding to the broadcaster. For example, if the broadcaster is traveling in a foreign country, the suggested topics may relate to the geographic location, e.g., culture, cuisine, sightseeing, points of interest, events occurring at the geographic location, to name some examples. In some embodiments, the topic module 208 can determine suggested topics based on events corresponding to the broadcaster. For example, if the broadcaster has been posting updates to the social networking system about a newborn baby, then the topic module 208 can determine that the first user is a new parent. Based on this determination, the topic module 208 can propose the baby as a suggested topic for the broadcast.

Once the broadcaster decides to conduct the broadcast, the broadcaster can select, or specify, a given time for the broadcast and, optionally, any topics for the broadcast. Based on this specified information, the event module 210 can create calendar events corresponding to the broadcast. In some embodiments, such calendar events can be posted to the respective calendars of the users that expressed an interest in the broadcast. Such calendars may be accessible through the social networking system, for example. In some embodiments, the event module 210 sends notifications describing the details of the broadcast to the users that expressed an interest in the broadcast. Such notifications can be sent to the users through the social networking system, as e-mails, and/or as messages over various networks, for example.

FIG. 3 illustrates an example of a broadcast optimization module 302, according to an embodiment of the present disclosure. In some embodiments, the broadcast optimization module 108 of FIG. 1 can be implemented as the broadcast optimization module 302. As shown in FIG. 3, the broadcast optimization module 302 can include a broadcast initiation module 304, an engagement prediction module 306, a topic module 308, and a broadcast time module 310.

As mentioned, the broadcast optimization module 302 can be configured to provide broadcasting users (e.g., users of the social networking system 730 of FIG. 7) with information such as broadcast times and/or broadcast topics that are predicted to drive optimal user engagement. In various embodiments, a broadcaster that is interested in conducting a broadcast through the social networking system can interact with the broadcast initiation module 304 to determine times and/or topics for optimizing the audience for the broadcast. The broadcast initiation module 304 can be configured to receive such broadcast information requests from the broadcaster, for example, through an interface (e.g., graphical user interface, application programming interface, etc.). For example, the broadcaster may interact with the broadcast initiation module 304 through a software application running on a computing device of the broadcaster.

A broadcast information request may propose one or more parameters for the broadcast. For example, in some embodiments, the request may specify one or more times at which the broadcaster wants to broadcast and/or one or more topics for the broadcast. In such embodiments, the engagement prediction module 306 can be trained to predict respective audiences (e.g., a total number of users) that are expected to access, or view, the broadcast for each of the specified times and topics. For example, in some embodiments, the engagement prediction module 306 can utilize one or more machine learning models that have been trained to predict audiences for broadcasts based on various inputs (e.g., broadcast times, topics, or both). In some embodiments, a model can be trained using a set of training examples that each describe a broadcast that was previously conducted through the social networking system. In such embodiments, the training examples may include one or more of the following features: an identity of the user that conducted a broadcast, interests of the user that conducted the broadcast, characteristics of the user that conducted the broadcast, a geographic location from which the broadcast was conducted, any topics related to the broadcast, a time period during which the broadcast was conducted, a number of social connections and/or fans of the user that were accessing the social networking system during the broadcast time period, a number of social connections and/or fans of the user online during the broadcast time period that were notified of the broadcast, a number of social connections and/or fans online during the broadcast time period that accessed (e.g., viewed) the broadcast, interests of the users that accessed the broadcast, the number of users that accessed the broadcast and selected a reaction option, e.g., like option or positive/negative reactions (e.g., happy, sad, funny, interesting, etc.) from a set of reactions, interests of the users that did not access the broadcast, the number of users that accessed the broadcast and did not select a reaction option, e.g., like option or reactions (positive or negative) from a set of reactions, and demographics of the users that did and did not access the broadcast. In one example, the model can be trained using training examples that each identify the user that conducted a broadcast, a time period during which the broadcast was conducted, topics corresponding to the broadcast, and a number of fans online during the broadcast time period that accessed (e.g., viewed) the broadcast. In this example, the trained model can predict the audience (e.g., a total number of users) that may access a future broadcast given the user conducting the broadcast, the time period during which the broadcast will be conducted, and broadcast topic(s). In some embodiments, generally known content processing and/or speech recognition techniques may be applied to data describing previous broadcasts to determine any respective topics that relate to a broadcast. Such topics can be used to train the machine learning models as described above.

In some embodiments, the initiation request may specify one or more times at which the broadcaster is considering broadcasting without specifying any topics. In such embodiments, the engagement prediction module 306 can predict respective audiences (e.g., a total number of users) that are expected to access, or view, the broadcast for each of the specified times. As mentioned, the engagement prediction module 306 can utilize one or more trained machine learning models for predicting audiences for broadcasts. In one example, the model can be trained using training examples that each identify the user that conducted a previous broadcast, a time period during which the broadcast was conducted, and a number of social connections and/or fans that accessed (e.g., viewed) the broadcast. In this example, the trained model can predict the audience (e.g., a total number of users) that may access a future broadcast given the user conducting the broadcast and the broadcast time period (e.g., time of day, day of the week, date, month, etc.). In some embodiments, the topic module 308 can be configured to suggest one or more topics for the broadcast. For example, the topic module 308 can generate a set of suggested topics for the user as described above in reference to the topic module 208 of FIG. 2. In such embodiments, the engagement prediction module 306 can be trained to predict which of the suggested topics are likely to draw the largest audiences for the broadcast. For example, a model can be trained using training examples that each identify the user that conducted a previous broadcast, a broadcast time period, one or more topics for the broadcast, and a number of social connections and/or fans that accessed (e.g., viewed) the broadcast. In this example, the trained model can predict the audience (e.g., a total number of users) that may access a future broadcast given the user conducting the broadcast, the broadcast time period, and topic(s) for the broadcast.

In some embodiments, the initiation request may specify one or more topics for the broadcast without specifying times for the broadcast. In such embodiments, the engagement prediction module 306 can be trained to predict respective audiences (e.g., a total number of users) that are expected to access, or view, the broadcast for each of the specified topics. For example, a model can be trained using training examples that each identify the user that conducted a previous broadcast, one or more topics for the broadcast, and a number of fans that accessed (e.g., viewed) the user's broadcast. In this example, the trained model can predict the audience (e.g., a total number of users) that may access a future broadcast given the user conducting the broadcast and topic(s) for the broadcast. As mentioned, in some embodiments, the engagement prediction module 306 can be trained to predict which times are likely to draw the largest audiences for the broadcast. In some embodiments, the broadcast time module 310 can be configured to provide different time periods (e.g., time of day, day of the week, date, month, etc.) as inputs to the model to determine the respective audiences that are expected to tune-in to a broadcast by a user during a given time period. Based on outputs from the model, the broadcast time module 310 can determine one or more optimal time periods that are likely to draw the largest audiences for the broadcast. The broadcast time module 310 can provide the one or more optimal time periods as suggestions to the broadcaster. Naturally, the models described herein can be trained to predict audiences for various time periods during which a broadcast may be conducted and/or topics for the broadcast while being agnostic to the identity of the user conducting the broadcast.

In general, the models described herein may be trained using data describing past broadcasts (e.g., live content streams) and/or on-demand content streams (e.g., pre-recorded content items posted by users). In some instances, a user may not have conducted enough broadcasts in the past to allow a model to be trained to accurately predict audiences. In some embodiments, rather than relying only on data from past broadcasts, the models described herein can be trained based on posts of the broadcaster that are published through the social networking system. For example, a model can be trained using a set of training examples that each describe a post that was previously published by the broadcaster. In such embodiments, the training examples may include one or more of the following features: an identity of the broadcaster that posted, interests of the broadcaster, characteristics of the broadcaster (e.g., information describing users that is available in a social graph being managed by a social networking system), a geographic location from which the posted was submitted, any topics associated with the post, a timestamp associated with the post, a number of social connections and/or fans of the user that selected an option to “like” the post (or other measurements of user engagement, e.g., views, comments, shares), and a time period (e.g., time of day, day of the week, date, month, etc.) during which the post received the most user engagement (e.g., likes, views, comments, shares, etc.). In one example, the model can be trained using training examples that each identify the user that posted, any topics associated with the post, a time period during the day during which the post received the most user engagement, interests of the users that accessed the post, the number of users that accessed the post and selected a reaction option, e.g., like option or positive/negative reactions (e.g., happy, sad, funny, interesting, etc.) from a set of reactions, interests of the users that did not access the post, the number of users that accessed the post and did not select a reaction option, e.g., like option or reactions (e.g., positive or negative) from a set of reactions, and demographics of the users that did and did not access the post. In this example, the trained model can predict the audience (e.g., a total number of users) that may access a future broadcast given the user, the broadcast time period, and topic(s) for the broadcast. As mentioned, in some instances, a user may not have conducted enough broadcasts in the past to allow a model to be trained to accurately predict audiences. Therefore, in some embodiments, the models described herein can be trained to provide broadcast suggestions for the user based on how that user is similar to other broadcasters that have conducted broadcasts in the past. For example, similarity between broadcasters can be determined based on their identities, interests, characteristics, locations of broadcast, and times of broadcast, to name some examples.

In addition to predicting the audience that is expected to tune-in to a given broadcast, in some embodiments, the models described herein may be trained to predict other forms of user engagement such as an average duration users are expected to access a broadcast presented by a given user, an average duration users are expected to access a broadcast presented over a given time period, and/or an average duration users are expected to access a broadcast presented on a given topic. Other example models may be trained to predict a number of users that are expected to select an option to “like” a broadcast, to post comments in response to the broadcast, to share the broadcast, to name some examples. In some embodiments, when predicting an audience, the models can output a score measuring the expected user engagement for a broadcast. For example, the score can be based on a number of users that are expected to view the broadcast, an average duration of time that users are expected to view the broadcast, and/or a number of users expected to interact (e.g., like, comment, share, etc.) with the broadcast. In some embodiments, the model can provide suggestions to the user for a duration of time over which to conduct the broadcaster. These suggestions can be determined in part on the average duration of time that users are expected to view the broadcaster, for example. In one example, a suggested duration of time can be influenced based on the time of day. For example, a duration of time suggestion for a broadcast being conducted in the morning (e.g., breakfast time) may be shorter than one for a broadcast being conducted in the evening (e.g., after work hours). In some embodiments, when providing suggestions for broadcast topics, the model can also determine suggested topics based in part on the respective interests of the audience that is expected to access the broadcast. For example, users may specify their interests in their respective social profiles or, in some instances, may demonstrate their interests based on the types of content they access. Such user interests can be used influence a suggestion for one topic over another.

FIG. 4 illustrates an example of a broadcast suggestion module 402, according to an embodiment of the present disclosure. In some embodiments, the broadcast suggestion module 110 of FIG. 1 can be implemented as the broadcast suggestion module 402. As shown in FIG. 4, the broadcast suggestion module 402 can include an engagement prediction module 404, an audience generation module 406, and an event notification module 408. In some embodiments, the engagement prediction module 306 of FIG. 3 can be implemented as the engagement prediction module 404.

As mentioned, the broadcast suggestion module 402 can be configured to automatically determine a broadcast event for a broadcaster (e.g., user of the social networking system 730 of FIG. 7). In some embodiments, the broadcast suggestion module 402 can also generate an audience for the broadcast. Once an audience for the broadcast event is established, the broadcast suggestion module 402 can provide a notification to suggest the broadcast to the broadcaster. The operations performed by the broadcast suggestion module 402 may be triggered differently depending on the implementation. For example, in some embodiments, the operations may be triggered at random. In some embodiments, the operations may be triggered when the broadcaster experiences a life event (e.g., user gets engaged, married, has a baby, etc.). Such life events may be determined based on the broadcaster's actions through the social networking system including, for example, posted media items, posts, and/or updates to the broadcaster's social profile (e.g., updating profile to indicate married status). In some embodiments, the operations may be triggered when a determination is made that the broadcaster is traveling outside of their home geographic region.

In various embodiments, the engagement prediction module 404 can utilize one or more machine learning models to predict an audience for a broadcaster. For example, in some embodiments, the engagement prediction module 404 can utilize models that have been trained to predict an audience for a broadcaster if the broadcaster conducts a broadcast on any topic and at any time. In some embodiments, the engagement prediction module 404 can utilize models that have been trained to predict an audience for a broadcaster if the broadcaster conducts a broadcast on a given topic (or topics). In some embodiments, the engagement prediction module 404 can utilize models that have been trained to predict an audience for a broadcaster if the broadcaster conducts a broadcast at a given time. In some embodiments, the engagement prediction module 404 can utilize models that have been trained to predict an audience for a broadcaster if the broadcaster conducts a broadcast at a given time and on a given topic (or topics). In some embodiments, the engagement prediction module 404 can utilize models that have been trained to predict an audience for a broadcaster if the broadcaster conducts a broadcast from a certain geographic location and/or point of interest. Such models can be trained using various training examples as described above. In some embodiments, the engagement prediction module 404 can utilize models that have been trained to predict an audience for a broadcaster if the broadcaster conducts a broadcaster with one or more other users as co-broadcasters. For example, the broadcaster may be notified that adding a certain co-broadcaster (regardless of the co-broadcaster's geographic location) can result in a larger audience and/or a more favorable reaction from the audience. In some embodiments, the engagement prediction module 404 can utilize models that have been trained to provide directorial suggestions for broadcasts. Such models may be trained using past broadcast data that specifies the type of lighting used, the positioning of the broadcaster, camera angles (e.g., ratio of broadcaster face to the background), the types of music that was played during the broadcast, ambient noises during the broadcast, the types of camera effects used, to name some example features. These features can be trained using a set of labels that describe the audiences that accessed the broadcasts, as described above. These example features can be determined using generally known techniques for audio and video processing. Once trained, these models can be utilized to provide a broadcaster with various directorial suggestions for their upcoming broadcast.

In some embodiments, the audience generation module 406 can determine if a predicted audience satisfies a threshold (e.g., a minimum number of users that are expected to view the broadcast). If the threshold is satisfied, the audience generation module 406 can be configured to build an audience for the broadcast. Depending on the implementation, the threshold may vary depending on the user, topic, and/or broadcast time. In some embodiments, no threshold needs to be satisfied for the audience generation module 406 to build the audience. When building an audience, the audience generation module 406 may send notifications to users that may be interested in viewing the broadcast. A user notification can be presented in a content feed of the user being notified, for example. In some embodiments, the audience generation module 406 notifies users that have selected options to “like” or “fan” a page corresponding to the broadcaster and/or users that have otherwise been identified by the social networking system as fans of the broadcaster. In some embodiments, the users notified may be recognized as social connections (e.g., first degree social connections) of the broadcaster by the social networking system. In some embodiments, the users notified may have additional degrees of separation (e.g., second degree social connections, third degree social connections, etc.) from the broadcaster. In some embodiments, when notifying users, the audience generation module 406 may also poll the users to determine a number of users that are interested in viewing the broadcast.

The event notification module 408 can be configured to send notifications to the broadcaster including information describing the proposed broadcast event. Such information may indicate the expected audience for the event, suggested topic(s), suggested time period(s) over which to conduct the broadcast, suggested geographic location(s) from which to conduct the broadcast, to name some examples. In some embodiments, when multiple topics are suggested, the broadcaster can be provided with a suggested order in which to discuss the multiple topics. In some embodiments, audience feedback (e.g., reactions, comments, etc.) can be analyzed, for example using sentiment analysis techniques, to provide the broadcaster with real-time suggestions to discontinue coverage of a certain topic and move to a different topic, or to modify the order in which the topics are discussed. In some instances, two different broadcasters that plan to conduct related broadcasts (e.g., related topics, shared audience, etc.) may be provided suggestions for broadcasting at the same time and/or location. To prevent conflicting broadcasts that may split the audience, in some embodiments, such broadcasters can be provided suggestions to stagger their broadcasts. For example, a first broadcaster can be asked to conduct their broadcast over a first time period and a second broadcaster can be asked to conduct their broadcast over a delayed second time period. In some embodiments, the broadcaster can specify a threshold for the audience (e.g., minimum number of users) that is expected to view a broadcast conducted by the broadcaster. In such embodiments, the event notification module 408 does not send notifications to the broadcaster unless the specified threshold is satisfied.

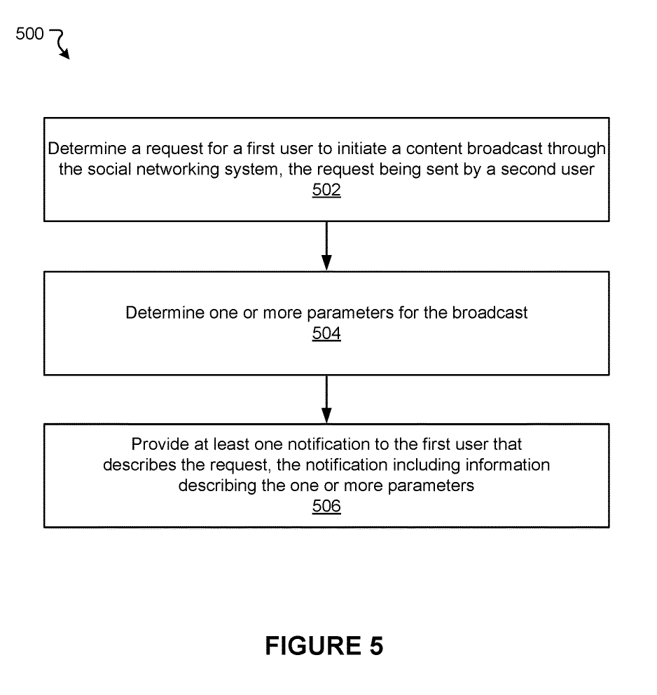

FIG. 5 illustrates an example process 500 for requesting a content broadcast, according to various embodiments of the present disclosure. It should be appreciated that there can be additional, fewer, or alternative steps performed in similar or alternative orders, or in parallel, within the scope of the various embodiments discussed herein unless otherwise stated.

At block 502, a determination is made of a request for a first user to initiate a content broadcast through the social networking system, the request being sent by a second user. At block 504, one or more parameters for the broadcast are determined. At block 506, at least one notification that describes the request is provided to the first user, the notification including information describing the one or more parameters.

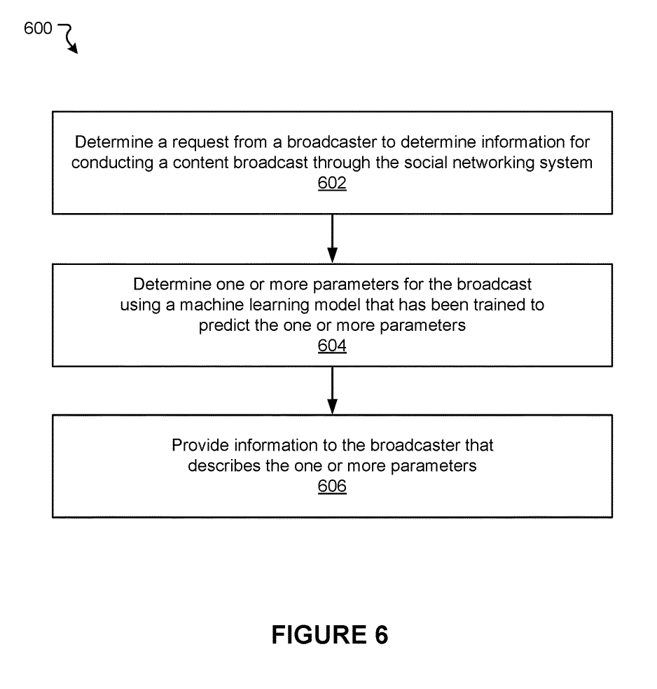

FIG. 6 illustrates an example process 600 for determining information for a content broadcast, according to various embodiments of the present disclosure. It should be appreciated that there can be additional, fewer, or alternative steps performed in similar or alternative orders, or in parallel, within the scope of the various embodiments discussed herein unless otherwise stated.

At block 602, a determination is made of a request from a broadcaster to determine information for conducting a content broadcast through the social networking system. At block 604, one or more parameters for the broadcast are determined using a machine learning model that has been trained to predict the one or more parameters based at least in part on data describing previously conducted broadcasts. At block 606, information that describes the one or more parameters is provided to the broadcaster.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System-Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content. As discussed previously, it should be appreciated that there can be many variations or other possibilities.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a content provider module 746. The content provider module 746 can, for example, be implemented as the content provider module 102 of FIG. 1. In some embodiments, the content provider module 746, in whole or in part, may be implemented in a user device 710 or the external system 720. As discussed previously, it should be appreciated that there can be many variations or other possibilities.

### Hardware Implementation

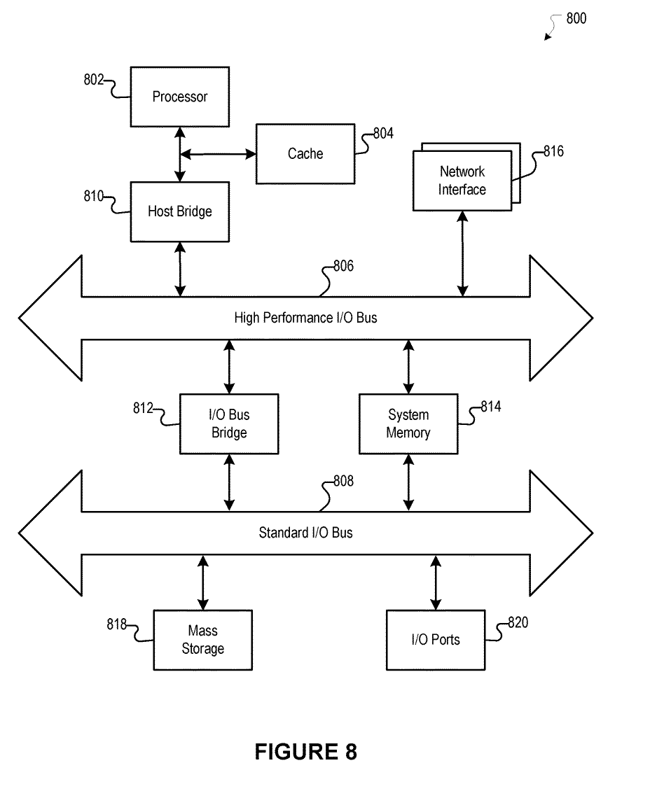

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, a request for a first user to initiate a live content broadcast through the computing system, the request being sent by a second user;
determining, by the computing system, one or more parameters for the live content broadcast, the one or more parameters specifying at least one topic for the live content broadcast; and
providing, by the computing system, at least one notification to the first user that describes the request, the notification including information describing the one or more parameters.

2. The computer-implemented method of claim 1, wherein determining one or more parameters for the broadcast further comprises:
providing, by the computing system, a polling questionnaire to one of more users of the computing system, the polling questionnaire requesting feedback for at least one topic for the broadcast; and
obtaining, by the computing system, feedback from at least one of the users in response to the polling questionnaire, wherein the feedback is included in the notification provided to the first user.

3. The computer-implemented method of claim 2, wherein the at least one topic for the broadcast is automatically generated based on information specified in a social profile of the first user.

4. The computer-implemented method of claim 2, wherein the at least one topic for the broadcast is automatically generated based on topics corresponding to posts that were published by the first user through a social networking system.

5. The computer-implemented method of claim 2, wherein the at least one topic for the broadcast is automatically generated based on a geographic location corresponding to the first user.

6. The computer-implemented method of claim 2, wherein the polling questionnaire is provided to a user as a content item in a content feed associated with the user.

7. The computer-implemented method of claim 1, wherein determining one or more parameters for the broadcast further comprises:
providing, by the computing system, a polling questionnaire to one of more users of the computing system, the polling questionnaire requesting feedback for at least one time for conducting the broadcast; and
obtaining, by the computing system, feedback from at least one of the users in response to the polling questionnaire, wherein the feedback is included in the notification provided to the first user.

8. The computer-implemented method of claim 1, wherein determining one or more parameters for the broadcast further comprises:
providing, by the computing system, a polling questionnaire to one of more users of the computing system, the polling questionnaire requesting feedback for at least one geographic location from which to conduct the broadcast; and
obtaining, by the computing system, feedback from at least one of the users in response to the polling questionnaire, wherein the feedback is included in the notification provided to the first user.

9. The computer-implemented method of claim 1, wherein determining one or more parameters for the broadcast further comprises:
providing, by the computing system, a polling questionnaire to one of more users of the computing system, the polling questionnaire requesting feedback on whether the users are interested in viewing the broadcast;
obtaining, by the computing system, feedback from at least one of the users in response to the polling questionnaire; and
determining, by the computing system, information describing an audience that is interested in the broadcast based at least in part on the feedback, wherein the information is included in the notification provided to the first user.

10. The computer-implemented method of claim 1, wherein the information describing the audience includes at least one of information describing users that are interested in the broadcast, a size of the audience, demographic information describing the users interested in the broadcast.

11. A system comprising:
at least one processor; and
a memory storing instructions that, when executed by the at least one processor, cause the system to perform:
determining a request for a first user to initiate a live content broadcast through the computing system, the request being sent by a second user;
determining one or more parameters for the live content broadcast, the one or more parameters specifying at least one topic for the live content broadcast; and
providing at least one notification to the first user that describes the request, the notification including information describing the one or more parameters.

12. The system of claim 11, wherein determining one or more parameters for the broadcast further causes the system to perform:
providing a polling questionnaire to one of more users of the computing system, the polling questionnaire requesting feedback for at least one topic for the broadcast; and
obtaining feedback from at least one of the users in response to the polling questionnaire, wherein the feedback is included in the notification provided to the first user.

13. The system of claim 12, wherein the at least one topic for the broadcast is automatically generated based on information specified in a social profile of the first user.

14. The system of claim 12, wherein the at least one topic for the broadcast is automatically generated based on topics corresponding to posts that were published by the first user through a social networking system.

15. The system of claim 12, wherein the at least one topic for the broadcast is automatically generated based on a geographic location corresponding to the first user.

16. A non-transitory computer-readable storage medium including instructions that, when executed by at least one processor of a computing system, cause the computing system to perform a method comprising:
determining a request for a first user to initiate a live content broadcast through the computing system, the request being sent by a second user;
determining one or more parameters for the live content broadcast, the one or more parameters specifying at least one topic for the live content broadcast; and
providing at least one notification to the first user that describes the request, the notification including information describing the one or more parameters.

17. The non-transitory computer-readable storage medium of claim 16, wherein determining one or more parameters for the broadcast further causes the computing system perform:
providing a polling questionnaire to one of more users of the computing system, the polling questionnaire requesting feedback for at least one topic for the broadcast; and
obtaining feedback from at least one of the users in response to the polling questionnaire, wherein the feedback is included in the notification provided to the first user.

18. The non-transitory computer-readable storage medium of claim 17, wherein the at least one topic for the broadcast is automatically generated based on information specified in a social profile of the first user.

19. The non-transitory computer-readable storage medium of claim 17, wherein the at least one topic for the broadcast is automatically generated based on topics corresponding to posts that were published by the first user through a social networking system.

20. The non-transitory computer-readable storage medium of claim 17, wherein the at least one topic for the broadcast is automatically generated based on a geographic location corresponding to the first user.
